(19) United States
(12) Patent Application Publication
(10) Pub. No.: US 2010/0332529 A1
(43) Pub. Date: Dec. 30, 2010

(54) Mapping Of Metadata Between A Web Service And A Line-Of-Business System

(75) Inventors: Tapas K. Nayak, Hyderabad (IN); Jayanthi Sampathkumar, Hyderabad (IN); Anil Prasad, Hyderabad (IN); Mustansir Doctor, Hyderabad (IN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/490,518

(22) Filed: Jun. 24, 2009

(51) Int. Cl. G06F 17/30; G06F 7/00

(52) U.S. Cl. 707/770; 707/791; 707/802; 707/803; 707/812; 707/674

(57) ABSTRACT

Techniques are provided for interfacing clients with line of business (LOB) systems through a web service. An operation of the LOB system that the LOB system is configured to perform is selected. The selected operation is indicated in a metadata map. A first mapping is included in the metadata map of one or more LOB-side parameters of the operation to corresponding service-side parameters. A second mapping is included in the metadata map of one or more LOB-side types associated with the LOB-side parameters to corresponding service-side types. The metadata map may be serialized into a service contract. The service contract may be used by the web service to expose the LOB system to clients. The metadata map may be deserialized and used by the web service to map messages between the web service and LOB system.

### BACKGROUND

A line of business (LOB) system is a resource that may be computer-based, and is configured to service one or more particular business needs. For example, a LOB system may perform accounting, order processing, supply chain management, resource planning, database management and/or further enterprise-related functions. A web service may be used to enable access to a LOB system to clients (e.g., computer systems) over a network. For instance, requests from a client may be sent to the LOB system over the network through the web service. Responses to the requests may be transmitted from the LOB system through the web service and network back to the client.

LOB systems include “metadata” that is representative of the operations and data accessible at the LOB systems. Each different LOB system may have its own format of metadata. As such, integration of web services with LOB systems is challenging. This is due to variations in the metadata formats used by the LOB systems, including non-standard metadata formats, large amounts of metadata, etc. Thus, interfaces between web services and LOB systems typically are created on a custom basis, which is very inefficient.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques are provided for interfacing clients with line of business (LOB) systems through a web service. A metadata map is generated to enable the interfacing in a standard manner. An operation of an LOB system may be selected. The selected operation is indicated in a metadata map. The metadata map is further generated to map one or more LOB-side parameters of the operation to corresponding service-side parameters, and one or more LOB-side types associated with the LOB-side parameters to corresponding service-side types. The metadata map may be serialized into a service contract. The service contract may be used by the web service to expose the LOB system to clients. The metadata map may be deserialized and used by the web service to map messages between the web service and LOB system.

The metadata map may map names between the web service and the LOB system. For instance, a mapping may be included in the metadata map of a first name referenced at the LOB system for the selected operation to a second name configured to be referenced at the web service for the selected operation.

Still further, a mapping may be included in the metadata map of a first name referenced at the LOB system for a LOB-side parameter to a second name configured to be referenced at the web service for a service-side parameter that corresponds to the LOB-side parameter.

Still further, a mapping may be included in the metadata map of a first name referenced at the LOB system for a LOB-side type to a second name configured to be referenced at the web service for a service-side type that corresponds to the LOB-side type.

Still further, a mapping may be included in the metadata map of a first name referenced at the LOB system for a LOB-side type member to a second name configured to be referenced at the web service for a service-side type member that corresponds to the LOB-side type member.

The metadata map may be configured to map a portion of the metadata available at the LOB system with respect to the operation. For instance, an LOB-side parameter of the plurality of LOB-side parameters may be selected that is not to be exposed by the web service. A mapping of the selected LOB-side parameter to a service-side parameter may be removed from the metadata map. Similarly, mappings of type members associated with the operation may be removed from the metadata map.

In a further aspect, the web service may be initialized by deserializing the metadata map from the service contract. This may include deserializing an operation metadata, an operation parameter, a type metadata, and a type member from the service contract.

In further implementation, a method for communicating between a client and the LOB system through the web service is provided. A SOAP request message is received from a client regarding the operation. The SOAP request message is mapped to a LOB request message according to the generated metadata map. The LOB request message is transmitted to the LOB system. A LOB response message is received from the LOB system. The LOB response message is mapped to a SOAP response message according to the generated metadata map. The SOAP response message is transmitted to the client in response to the SOAP request message.

In another implementation, a metadata map generator tool is provided. The metadata map generator tool includes a metadata service, a metadata handler, and a metadata analyzer. The metadata service is configured to receive a request from a user to retrieve metadata for an operation from a LOB system. The metadata handler is configured to provide the operation metadata request to the LOB system, and to receive operation metadata associated with the operation from the LOB system. The metadata analyzer is configured to generate a metadata map based at least on the operation metadata, and to serialize the metadata map into a service contract.

Furthermore, the metadata service may be configured to determine whether the operation metadata includes one or more parameters that reference a complex type. The metadata handler may be configured to provide a type metadata request associated with a complex type to the LOB system, and to receive type metadata associated with the complex type from the LOB system, if the complex type is determined to be referenced by a parameter. The metadata analyzer may be configured to generate the metadata map based at least on the operation metadata and the type metadata.

Furthermore, the metadata map generator tool may include an interface module configured to generate an interface to enable the user to modify the generated metadata map. In one aspect, the interface may be configured to enable the user to perform at least one of changing a service-side name of the operation, a service-side name of a parameter of the operation, a service-side name of a type associated with the parameter, or a service-side name of a type member associated with the type. In another aspect, the interface may be configured to enable the user to configure at least one of a parameter of the operation or a type member of a type associated with the parameter to not be exposed on the service-side.

In another implementation, a web service is provided. The web service includes a web service module, a contract analyzer, and a LOB adaptor. The web service module is configured to expose an operation at a web service according to a service contract. The service contract includes a serialized metadata map that maps metadata associated with the operation between the web service and a line of business (LOB) system. The contract analyzer is configured to deserialize the metadata map into an intermediate data structure form. The LOB adaptor is configured to use the deserialized metadata map to map metadata messages between the web service and the LOB system.

Methods, systems, and computer program products (stored on a computer readable medium) are also described herein that are capable of performing and/or enabling the methods described above and elsewhere herein, including the mapping of metadata from service-side format to an LOB format, mapping of metadata from LOB format to service-side format, and for implementing further embodiments as described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a transaction system, according to an example embodiment.

FIG. 2 shows a block diagram of a metadata map generator, according to an example embodiment.

FIG. 3 shows a block diagram of a transaction system, according to an example embodiment.

FIGS. 4 and 5 show block diagrams of metadata map generators, according to example embodiments.

FIG. 6 shows a block diagram of a metadata map generator tool, according to an example embodiment.

FIG. 7 shows a flowchart providing a process for communicating with a metadata map generator tool to generate a metadata map using a metadata map generating tool, according to an example embodiment.

FIG. 8 shows a flowchart providing an example process for generating a metadata map, according to an embodiment.

FIG. 9 shows a block diagram of a flow of metadata from a LOB system to a metadata map, according to an example embodiment.

FIG. 10 shows a flowchart providing a process for renaming an operation in a metadata map, according to an example embodiment.

FIG. 11 shows a flowchart for removing a parameter of an operation in a metadata map, according to an example embodiment.

FIG. 12 shows an example of a metadata web service configured for the deserialization of a metadata map into an intermediate data structure form, according to an embodiment.

FIG. 13 shows a flowchart for initializing a metadata web service, according to an example embodiment.

FIG. 14 shows a flowchart describing a communication protocol for performing an operation, according to an embodiment.

FIG. 15 shows the system of FIG. 3, and further illustrates communication signals, according to an example embodiment.

FIG. 16 shows a block diagram of a web service and an LOB system, according to an example embodiment.

FIG. 17 shows a block diagram of an example computer system that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### II. Example Embodiments

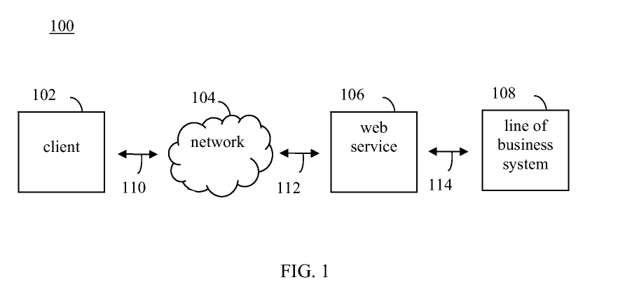

Embodiments of the present invention relate to techniques for mapping operations between line of business (LOB) systems and web services. Embodiments may be implemented in various environments. For example, in such an embodiment, a client may access a LOB system through a web service to perform operations. For instance, FIG. 1 shows a block diagram of a transaction system 100, according to an example embodiment. As shown in FIG. 1, system 100 includes a client 102, a network 104, a web service 106, and an LOB system 108. In system 100, client 102 accesses LOB system 108 across network 104 and through web service 106 to perform one or more operations. System 100 is further described as follows.

Client 102 may be an application configured to perform one or more functions, including one or more operations that access one or more resources, such as LOB systems. Client 102 may be implemented in hardware, software, firmware, or any combination thereof. For example, client 102 may be implemented as computer program code configured to be executed in one or more processors. Alternatively, client 102 may be implemented as hardware logic/electrical circuitry. For instance, client 102 may be implemented in a computer system, such as a stationary or mobile computing device, including a desktop computer (e.g., a personal computer), a mobile computer (e.g., a personal digital assistant (PDA), a laptop computer, a notebook computer, a smart phone, etc.), or other type of computing device.

Web service 106 and LOB system 108 may be located in a same computer system or separate computer systems. Web service 106 is a web service configured to support interoperable machine-to-machine interaction over network 104, including providing access to LOB system 108 to clients, such as client 102. For example, in an embodiment, web service 106 may be implemented according to the Windows Communication Foundation (WCF) programming framework distributed by Microsoft Corporation of Redmond, Wash., as a WCF service layer. LOB system 108 may be one or more applications configured to perform one or more functions that are accessible by clients. For example, LOB system 108 may be configured to perform one or more of an accounting function, an order processing operation, a banking and/or finance-related function, a supply chain management function, a resource planning function, a database management function, and/or any other suitable function. For instance, LOB system 108 may provide enterprise software and/or database functions, including an SQL (structured query language) database, an Oracle® database (distributed by Oracle Corporation of Redwood Shores, Calif.), a Siebel database (distributed by Oracle Corporation), etc.

Computer 102 is shown in FIG. 1 as communicating with web service 106 through network 104 and communication links 110 and 1 12. For example, as shown in FIG. 1, computer 102 is communicatively coupled with network 104 through a first communication link 110, and web service 106 is communicatively coupled with network 104 through a second communication link 112. LOB system 108 is shown communicatively coupled with web service 106 through a third communication link 114. Network 104 may be a LAN, WAN (wide area network), or combination of networks, such as the Internet. First-third communication links 110a-110c may include any type or combination of communication links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc. In an embodiment where web service 106 and LOB system 108 are located in a same computer system, third communication link 114 may be an inter-computer communication link.

Although a single LOB system 108 is shown in FIG. 1, additional LOB systems may be present in system 100 that are accessible by client 102 through one or more web services 106. Furthermore, although a single client 102 is shown in FIG. 1, multiple clients 102 may be configured to access LOB system 108 through web service 106.

Client 102 and web service 106 may be configured to communicate with each other through network 104 in various ways. Various types of communications between client 102 and web service 106 may be performed, including communication protocols such as SOAP (simple object access protocol) over HTTP (hypertext transfer protocol), SOAP over TCP (transmission control protocol), SOAP over Message Queues, and/or further communication protocols.

LOB systems include “metadata” which is representative of the operations, data, and other features accessible at the LOB systems. LOB systems frequently each have their own metadata format. As such, integration of web service 106 with LOB system 108 may be challenging. Interfaces between web services and LOB systems are currently typically created on a custom basis due to the various metadata formats.

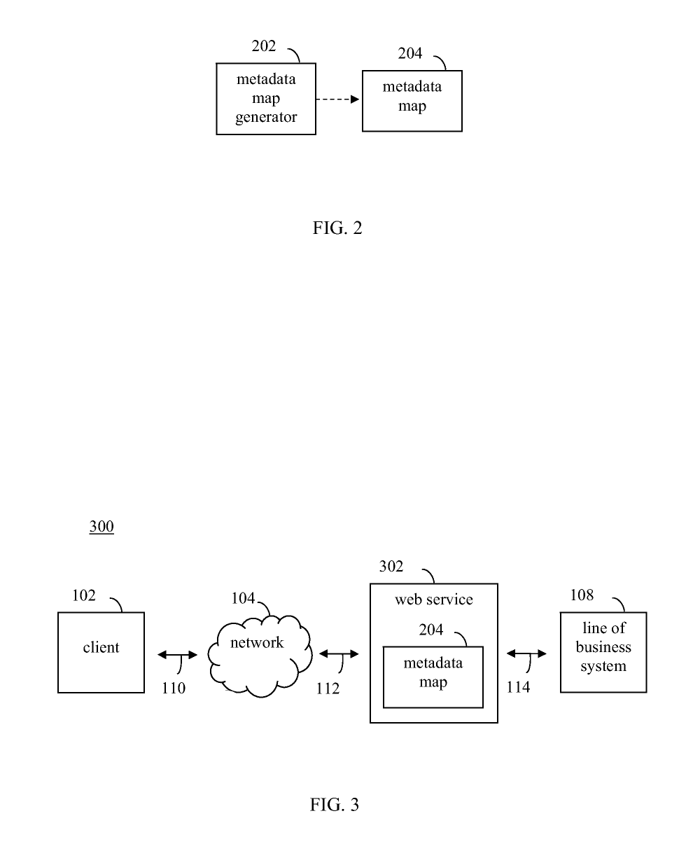

In an embodiment, a metadata map is generated that enables improved integration between web services and LOB systems. For instance, FIG. 2 shows a block diagram of a metadata map generator 202, according to an example embodiment. As shown in FIG. 2, metadata map generator 202 is configured to generate a metadata map 204. Metadata map 202 provides a framework for mapping LOB system services to deployable and manageable web services. In previous solutions, LOB system metadata was mapped to web service metadata dynamically at runtime, and validation of messages was not possible because design time metadata was not present. Embodiments generate metadata map 204 at design time, and the metadata of metadata map 204 may be placed in a readily useable form at a time of web service initialization, to used at runtime to enable messages to be passed between LOB system 108 and web service 106.

For instance, FIG. 3 shows a block diagram of a transaction system 300, according to an example embodiment. System 300 in FIG. 3 is similar to system 100 shown in FIG. 1, with differences described as follows. As shown in FIG. 3, system 300 includes client 102, network 104, a metadata web service 302, and LOB system 108. In system 300, client 102 accesses LOB system 108 across network 104 and through metadata web service 302 to perform one or more operations. As shown in FIG. 3, metadata web service 302 includes metadata map 204. Metadata web service 302 is generally similar to web service 106, and is configured to use metadata map 204 to map messages received from client 102 in a service-side format to messages that can be transmitted to LOB system 108 in a format recognized by LOB system 108. Furthermore, metadata web service 302 is configured to use metadata map 204 to map messages received from LOB system 108 in a format recognized by LOB system 108 to a service-side format that can be transmitted to client 102.

As mentioned above, LOB systems have large amounts of metadata that may be maintained in a proprietary format. In embodiments, an LOB adapter of the web service provides a uniform interface to convert disparate metadata formats into a web service compliant format using metadata map 204. The LOB adaptor also provides for reverse mapping, so that the LOB adapter can convert web service compliant messages into a LOB specific message format that can be passed to the LOB system to invoke LOB operation. The mapping is determined by a system integrator (e.g., a person knowledgeable about LOB systems) during design of a LOB service, and the determined mapping is serialized (e.g., converted into a form that is readily storable in storage) along with the definition of the web service. The mapping may be serialized in various forms, including but not limited to attributes on a C# and/or Visual Basic contract definition, attachment properties in XAML (extensible application markup language) serialization of service, XML (extensible markup language) serialization of service, etc.

Embodiments are described in the following subsections. For instance, the design time serialization of a LOB system/web service metadata map into a service definition is described in a next subsection, and in a following subsection, the runtime deserialization of the metadata map from a service definition to a format which is easy and efficient to access by an LOB adapter of the web service is described. In still another subsection, examples of communications between client 102 and LOB system 108 through web service 106, using mapping provided by metadata map 204, are described.

### A. Example Embodiments for Generating a Metadata Map at Design Time

Example embodiments are described in this subsection for generating a metadata map. The example embodiments described herein are provided for illustrative purposes, and are not limiting. Furthermore, additional structural and operational embodiments, including modifications/alterations, will become apparent to persons skilled in the relevant art(s) from the teachings herein.

At design time, a LOB expert or other system integrator may configure a web service to enable clients to access a LOB system. The system integrator may select a LOB artifact (e.g., an operation) and decide to generate web service-side (or “service-side”) metadata for it. The web service-side metadata is exposed by the web service to clients desiring to access the LOB system through the web service. The clients may provide a request for the operation to be performed that is configured according to the exposed metadata. A mapping, referred to as a “metadata map” is configured to map the web service-side metadata to LOB system-side metadata. In this manner, a metadata map can be generated that enables access at web services to LOB systems that having any configuration of metadata, including metadata in proprietary formats. The metadata map enables a conversion of the proprietary LOB-side metadata to a service-side metadata that may be more standardized and easier for clients to handle.

In an embodiment, the service-side metadata may be configured to have a form that is more user-friendly, including having names for operations, operation parameters, data types, and data type members, that are more easily handled by the clients. For instance, names for such metadata at the LOB-side (in the LOB system) may be in a language (e.g., English, German, French, etc.) not understood by a user at the client, may have overly lengthy forms, etc. At the service-side, the metadata may be renamed to a language familiar with the user, to a shorter form, etc.

In an embodiment, a first web service module, such as a WCF metadata exporter, is extended to extend generated WSDL (Web Service Description Language) service descriptions (also referred to as “service contracts,” “service definitions,” and “LOB contracts”) with annotations for the metadata map. A second web service module, such as WCF metadata importer, may convert WSDL to objects which can be serialized into a service definition. The second web service module filters out annotations for metadata map 204 and adds them to the service definition in a way appropriate for the chosen serialization. Various forms of serialization may be used, including serializing metadata map 204 as attributes on a service contract as well as on generated Data Contract definitions. The whole service definition can be serialized as a C# code fragment, for example. Another example form of serialization is a service definition in XAML. In this embodiment, metadata map 204 is added as an extra serialized property on a service contract implementation, as well as attributes on types. Another form of XAML serialization may be used, where a service is implemented as a group of workflow activities. In such case, metadata map 204 is serialized as properties on these activities as well as attributes on types.

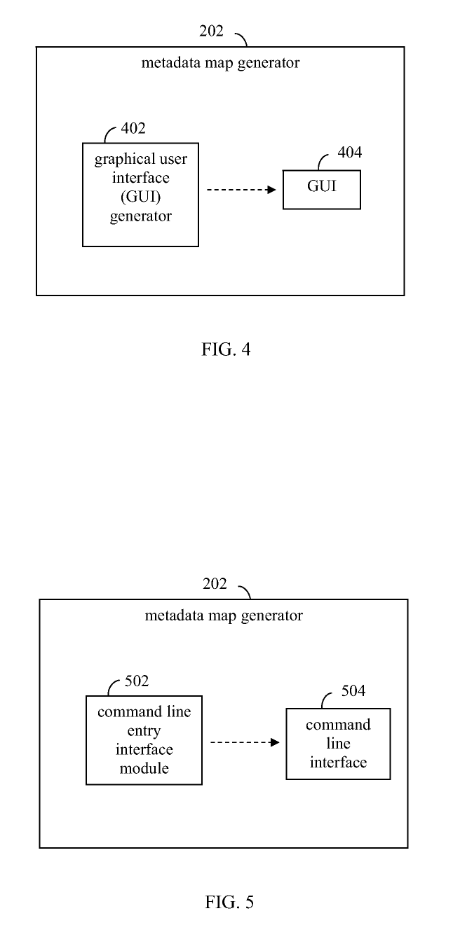

Metadata map 204 may be generated and configured in various ways. For example, FIG. 4 shows a block diagram of metadata map generator 202, according to an embodiment. As shown in FIG. 4, metadata map generator 202 includes a graphical user interface (GUI) generator 402 that generates a GUI 404. GUI 404 provides a GUI interface that may be used to configure a new or existing metadata map 204. In other embodiments, metadata map 204 may be configured in other ways. FIG. 5 shows another block diagram of metadata map generator 202, according to an embodiment. As shown in FIG. 5, metadata map generator 202 includes a command line entry interface module 502 that provides an interface (e.g., a command line interface 504) that may be used to configure a new or existing metadata map 204 by entering information (e.g., programming language code, etc.).

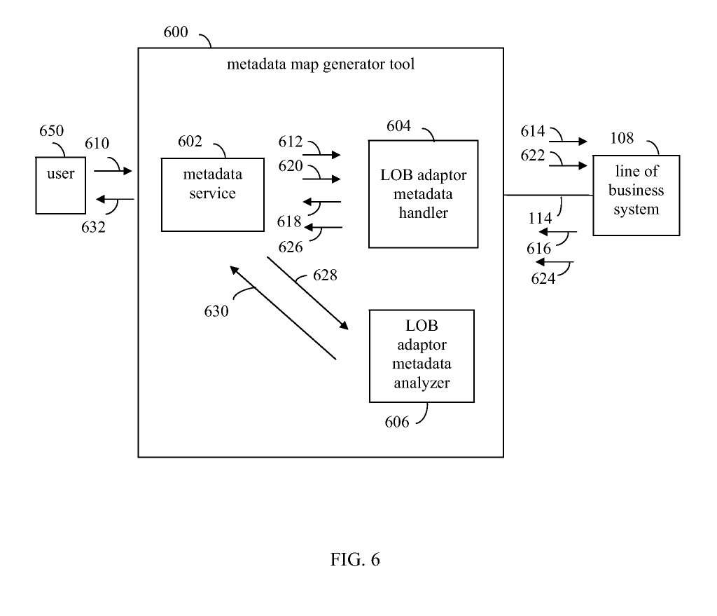

Metadata map generator 202 may be configured to generate and configure metadata map 202 during design time configuration of metadata map 204. For example, FIG. 6 shows a block diagram of a metadata map generator tool 600, according to an example embodiment. Metadata map generator tool 600 is an example of metadata map generator 202. As shown in FIG. 6, metadata map generator tool 600 includes a metadata service 602, a LOB adaptor metadata handler 604, and an adaptor metadata analyzer 606. Metadata map generator tool 600 may be implemented as an application programming interface (API), a computer-based application, or in other manner. Metadata map generator tool 600 is described as follows.

Metadata service 602 provides search and/or browse capabilities for searching LOB metadata and/or navigating through LOB metadata stored at LOB system 108. The browse functionality enables end users, such as a user 650 (e.g., a system integrator), to retrieve a list of LOB objects (e.g., operations) provided by LOB system 108, including all LOB objects or LOB objects of a given category. The search functionality enables user 650 to retrieve a list of LOB objects for the entire LOB application or for a given category that match user specified search criteria. Using metadata service 602, user 650 may find and select one or more LOB objects to be exposed by web service 302.

LOB adaptor metadata handler 604 is an interface for metadata service 602 to communicate with LOB system 108 to retrieve LOB objects. LOB adaptor metadata analyzer 606 is configured to generate a service description 630 for web service 302 based on the LOB objects retrieved by LOB adaptor metadata handler 604. Resolve functionality of some embodiments allows end users to receive the definition of LOB objects in standard format. Because the adapters facilitate the creation of web services from chosen LOB operations, some embodiments represent LOB objects as common language runtime (CLR) types. Based on how end users invoke the resulting web services, these objects can be represented in WSDL on non web service platforms.

When defining LOB objects, several factors may be taken into account. For example, embodiments may determine if an object in LOB system 108 is an object callable (e.g. subroutine/procedure/function) as an operation from outside of LOB system 108. Furthermore, embodiments may determine how an object may be invoked. Additionally, multiple LOB operations may be exposed to end-users as a single web service user operation, and whenever these operations are invoked by a user, the operations are invoked in the proper order. Additionally, in some situations, before invoking a LOB operation, LOB system 108 may require that proper context is set on a connection with LOB system 108. Information addressing each of these factors may be preserved in metadata, such as in metadata map 204.

Further factors that may be taken into account include factors related to input parameters and output parameters for the previously described operations. For example, information may be obtained by examining LOB metadata to determine how these parameters are received or provided by LOB system 108. For example, LOB system 108 may use a fixed buffer for taking in binary data with each parameter of fixed length and mapping to a fixed offset in the buffer. Information about input parameters and output parameters may also be stored as metadata in metadata map 204.

Additionally, the web service definition may include information related to parameter types, including primitive types such as int (integer), bool (Boolean), etc., or a collection of primitive types such as struct. Information may further be included in the web service definition that defines the mapping between LOB types being used in operation with CLR types, and may include information related to whether or not there is a one-to-one mapping between LOB types being used in operation with CLR types. If there is a one-to-one mapping between LOB type and CLR type, information about whether one of them is more restrictive may be included so that mapping can be handled appropriately. In situations where there is no mapping, the web service definition may define custom types aggregating business types.

Metadata web service 302 may be specified declaratively including declaring data contracts, message contracts and mapping information for mapping web service metadata to LOB metadata. Metadata web service 302 includes a contract and mapping information as well as a configuration piece, which can be used to provision metadata web service 302 according to integration need. Metadata web service 302 can either be compiled and saved in some file, can be deployed on a host, or can simply be saved in a repository for later provision and deployment.

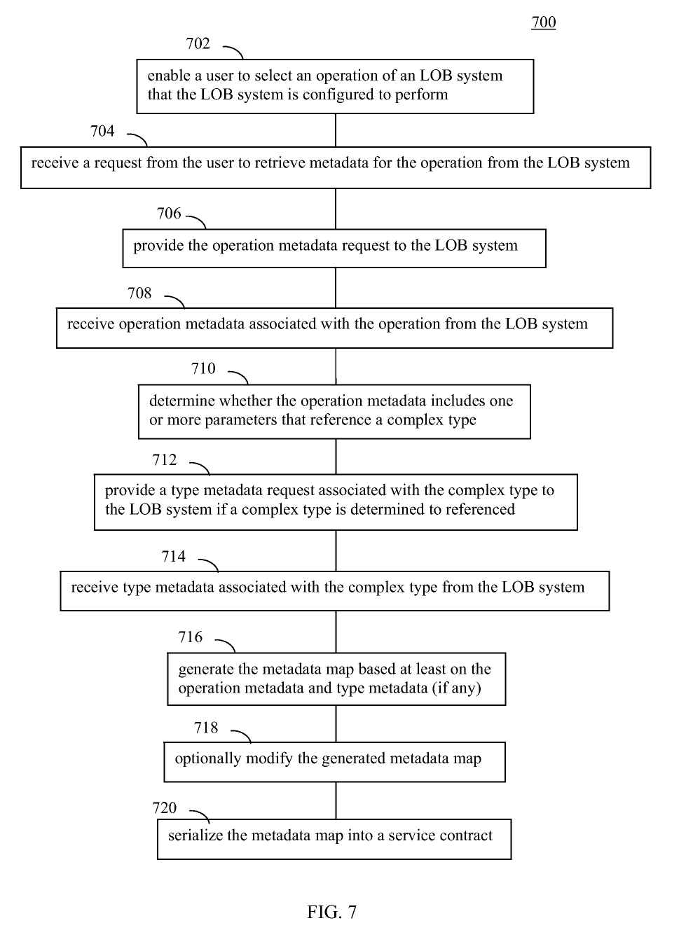

Referring to FIG. 6, user 650 may generate metadata map 204 by interacting with metadata map generator tool 600. For example, FIG. 7 shows a flowchart 700 providing a process for generating metadata map 204 using a metadata map generating tool, according to an example embodiment. Further structural and operational embodiments will be apparent to persons skilled in the relevant art(s) based on the discussion regarding flowchart 700. Flowchart 700 is described as follows.

Flowchart 700 begins with step 702. In step 702, a user is enabled to select an operation of an LOB system that the LOB system is configured to perform. For instance, as shown in FIG. 6, user 650 interacts with tool 600 to configure a metadata map. User 650 uses tool 600 to select an operation from a list of operations provided by LOB system 108 that user 650 may want to expose at metadata web service 302. For instance, user 650 may interact with GUI 404 shown in FIG. 4 or with command line interface 504 shown in FIG. 5, provided by metadata service 602 to select the operation.

In step 704, a request is received from the user to retrieve metadata for the operation from the LOB system. For example, referring to FIG. 6, user 650 generates a metadata get request 610, which is received by metadata service 602. For instance, user 650 may interact with GUI 404 shown in FIG. 4, or with command line interface 504, provided by metadata service 602 to generate metadata get request 610. Metadata get request 610 includes a request for metadata with respect to the operation of LOB system 108 selected in step 702.

In step 706, the request is provided to the LOB system. For example, as shown in FIG. 6, metadata service 604 transmits a resolve operation metadata request 612 to LOB adaptor metadata handler 604. Resolve operation metadata request 612 is a request for metadata associated with the operation indicated in metadata get request 610. LOB adaptor metadata handler 604 transmits a corresponding resolve operation metadata request message 614 to LOB system 108. Resolve operation metadata request message 614 may be transmitted to LOB system 108 according to any suitable communication protocol, including a proprietary protocol or conventionally available protocol.

Operations may be implemented at LOB system 108 in any suitable form, including the form of a programming language such as JavaScript, Visual Basic, C#, C++, other .NET compatible language, etc. For instance, for illustrative purposes, an example operation is shown as follows that may be implemented at LOB system 108 (shown in the C programming language, for example):

int24 foo(FooType input1, int26 input2);

In this example, the name of the operation at LOB system 108 is “foo”. “int24” is the type for the return data of the operation “foo.” The operation “foo” has two input parameters, which are “input1” and “input2”. The input parameter “input1” has the type “FooType” and the input parameter “input2” has the type “int26”. “int24” is a type that defines a 24 bit integer value, and “int26” is a type that defines a 26 bit integer value.” An example type definition for “FooType” is shown below:

```
FooType
{
        int18 member1;
        int30 member2;
}
```

The definition for “FooType” includes parameters “member1” and “member2”, respectively having types “int18” and “int30”.

In step 708, metadata associated with the operation is received from the LOB system. For example, as shown in FIG. 6, LOB system 108 transmits an operation metadata instance message 616 to LOB adaptor metadata handler 604 in response to resolve operation metadata request message 614. Operation metadata instance message 616 includes metadata associated with the operation indicated in resolve operation metadata request message 614. LOB adaptor metadata handler 604 transmits a corresponding operation metadata instance 618 to metadata service 602, which includes the operation metadata included in operation metadata instance message 616.

In step 710, whether the operation metadata includes one or more parameters that reference a complex type is determined. The operation metadata received from LOB system 108 includes a list of parameters to the operation, referred to as operation parameters. Each operation may have one or more associated data types. “Types” or “data types” are well known to persons skilled in the relevant art(s). A data type typically includes a name and a structure, which may be defined by a set of one or more members. Data types represent structured types of data that are processible by associated applications. A data type for a parameter may be a standard type, which is a data type that is standard and known to both LOB system 108 and web service 302, or may be a non-standard or complex type that is known to LOB system 108 but not known to web service 302. Thus, if metadata service 602 (or metadata handler 604) determines the retrieved operation metadata includes a parameter having a complex type, a data type definition for the complex type is to be retrieved from LOB system 108.

In step 712, if a complex type is determined to referenced, a type metadata request associated with the complex type is provided to the LOB system. Referring to FIG. 6, metadata service 602 transmits a resolve type metadata request 620 to LOB adaptor metadata handler 604 that includes a request for definition information regarding one or more complex data types. LOB adaptor metadata handler 604 transmits a corresponding resolve type metadata request message 622 to LOB system 108 for the one or more complex data types.

For instance, with reference to the example operation shown above, the operation is analyzed to determine whether any complex types are included. In this example, complex types are included, including the types “int24,” “FooType,” and “int 26.” These types are not known to metadata service 602. In this example, metadata service 602 may instead understand the standard type “int” as defining a 32-bit integer. Metadata describing the “int24,” “FooType,” and “int 26” types must be obtained from LOB system 108. As such, in this example a resolve type metadata request message 622 is generated requesting metadata for these types. Furthermore, when metadata describing “FooType” is obtained, another request message 622 may need to be transmitted to obtain metadata for the “int18” and “int30” types.

In step 714, type metadata associated with the complex type is received from the LOB system. For example, referring to FIG. 6, LOB system 108 transmits a type metadata instance message 624 to LOB adaptor metadata handler 604 in response to resolve type metadata request message 622. Type metadata instance message 624 includes type metadata associated with the one or more complex types from LOB system 108. LOB adaptor metadata handler 604 transmits a corresponding type metadata instance 626 to metadata service 602 that includes the type metadata.

In step 716, the metadata map is generated based at least on the operation metadata and type metadata (if any). For example, as shown in FIG. 6, metadata service 602 transmits the collected operation metadata, type metadata, and any other collected information to LOB adaptor metadata analyzer 606 in a service description request 628. LOB adaptor metadata analyzer 606 generates metadata map 204 based at least on the operation metadata and type metadata received in service description request 628.

For instance, with respect to the example operation described above, the following information may be generated (in serialized form), where the text “MetadataAttribute” is inserted (e.g., as a tag) to indicate the inclusion of metadata, which is followed by a definition of a mapping of the metadata from LOB-side to service-side. The following operation metadata and type metadata may be generated for the operation “int24 foo(FooType input1, int26 input2)”:

[return: MetadataAttribute(“DataLengthInBits”,24)]
int foo(FooType input1, [MetadataAttribute(“DataLengthInBits”,26)]
int input2);

where “[MetadataAttribute(“DataLengthInBits”,24)]” is metadata defining the “int24” LOB-side type for the return data of the operation “foo” with respect to the service-side type of “int” (e.g., mapping “int24” to “int”). Similarly, “[MetadataAttribute (“DataLengthInBits”,26)]” is metadata defining the “int26” LOB-side type with respect to the service-side type of “int” (e.g., mapping “int26” to “int”). With respect to “FooType”, the following type metadata may be generated with respect to the LOB-side type definition:

```
struct FooType
{
[MetadataAttribute(“DataLengthInBits”,18)]
        int member1;
[MetadataAttribute(“DataLengthInBits”,30)]
        int member2;
};
```

where “[MetadataAttribute(“DataLengthInBits”,18)]” is metadata defining the “int18” LOB-side type with respect to the service-side type of “int” (e.g., mapping “int18” to “int”). Furthermore, the “[MetadataAttribute(“DataLengthInBits”,30)]” is metadata defining the “int30” LOB-side type with respect to the service-side type of “int” (e.g., mapping “int30” to “int”).

In step 718, the generated metadata map is optionally modified. For example, in an embodiment, user 650 may be enabled to interact with tool 600 to modify metadata map 204 generated by LOB adaptor metadata analyzer 606. Example modifications that may be made to metadata map 204 are described further below.

In step 720, the metadata map is serialized into a service contract. For example, as shown in FIG. 6, LOB adaptor metadata analyzer 606 may generate a service contract or description 630 (e.g., a WSDL document) that includes metadata map 204, based on service description request 628. Service description 630 is provided to metadata service 602, and may be used to define interactions with metadata web service 302 by users, including exposing the operation selected in step 702 at LOB system 108.

For instance, with regard to the example operation described above, the serialized information shown above with respect to step 716 for the “foo” operation may be included in metadata map 204 in service description 630.

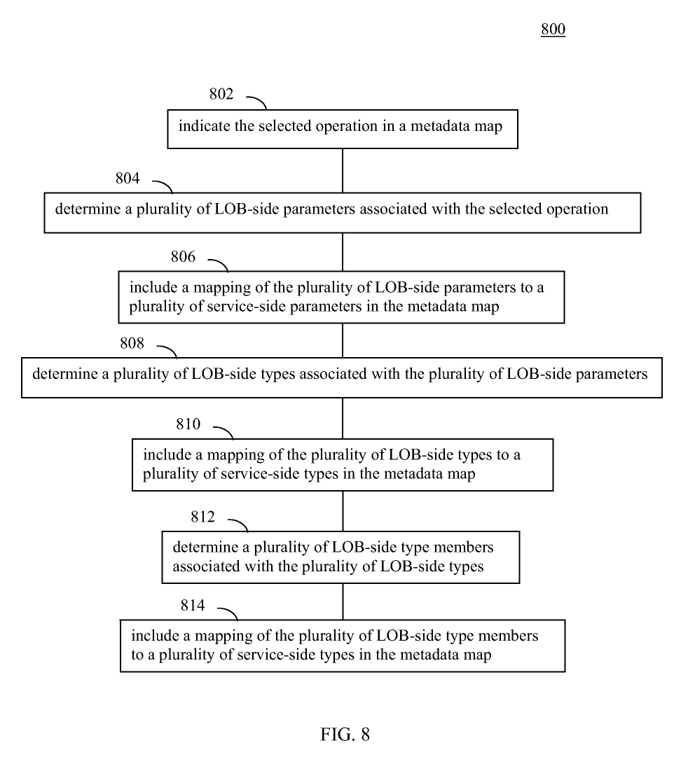

FIG. 8 shows a flowchart 800 providing an example process for generating metadata map 204, according to an embodiment. For example, FIG. 8 may be performed during step 716, and may be performed by LOB adaptor metadata analyzer 606 of FIG. 6. Further structural and operational embodiments will be apparent to persons skilled in the relevant art(s) based on the discussion regarding flowchart 800. Note that not all steps of flowchart 800 need be performed in all embodiments. Flowchart 800 is described as follows.

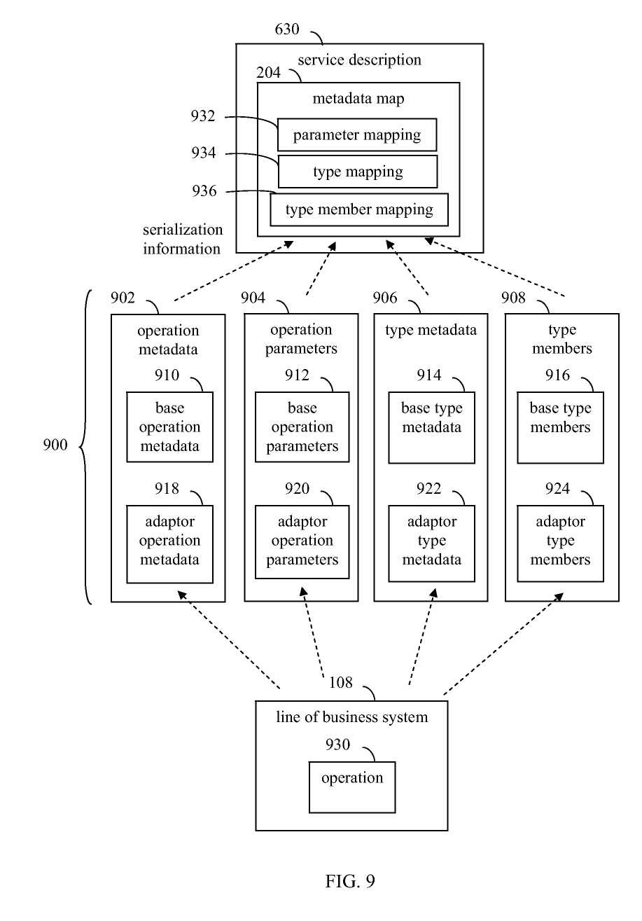

Flowchart 800 is described below with respect to FIG. 9. FIG. 9 shows a block diagram of a flow of metadata from LOB system 108 into metadata map 204 (in service description 630), according to an example embodiment. FIG. 9 shows metadata 900, which is the metadata retrieved from LOB system 108, and provided to LOB adaptor metadata analyzer 606 (in service description request 628). As shown in FIG. 9, metadata 900 includes operation metadata 902, operation parameters 904, type metadata 906, and type members 908, which are described as follows.

Operation metadata 902 includes metadata associated with an operation of LOB system 108. An LOB adaptor (that interfaces with LOB system 108 for metadata web service 302 during runtime) represents an operation as operation metadata 902. Operation metadata 902 has the context necessary to invoke the corresponding LOB operation. Because operation metadata 902 represents an operation, to allow operation input, operation metadata 902 includes an operation parameter collection, which is a list of operation parameters, with each operation parameter representing a parameter to the operation. Operation metadata 902 includes an operation result which is represented by an operation parameter. Each operation metadata 902 can have zero or more additional attributes specific to the corresponding LOB operation that are used for mapping.

Operation parameters 904 corresponds to the operation parameters included in the operation parameter collection. Operation parameters 904 is used to maintain context/metadata related to each operation parameter, which may include parameter direction, optional, or “isArray,” for example. Operation parameters 904 also contains type information about each operation parameter. This type information may indicate that a parameter may be mapped to standard types (known to metadata web service 302). Many LOB artifacts include non-standard types, and thus to support them, an LOB adaptor may allow operation parameter 904 to refer to custom types. These custom types are represented by type metadata 906. Each operation parameter 904 can have zero or more additional attributes specific to a corresponding LOB operation parameter that are used for mapping.

Type metadata 906 is used to represent custom LOB types. Type metadata 906 represents a structural type and is a collection of type members. Metadata for each type included in type metadata 906 may have zero or more extra attributes which define how to map the type to an LOB underlying type over and above its type members.

Type members 908 is used to specify elements belonging to type metadata 906. Type members 908 can be a simple type, such as mapping to an existing standard type, or may be a custom type mapping to a type instance included in type metadata 906. This enables recursiveness in type definitions. Type members 908 can include zero or more additional attributes that are specific to corresponding LOB type member.

The four metadata object types described above, namely operation metadata 902, operation parameters 904, type metadata 906 and type members 908 define the data structure in which LOB adapter code exposes the LOB metadata information. In a WCF configuration for metadata web service 302, a metadata export extension converts them to WSDL operation description as well as type descriptions. The same extension converts the additional attributes to special annotations on the WSDL. Furthermore, a metadata importer converts the WSDL back to service definition in which the importer extension converts special annotations back to one of the serialization forms mentioned above.

Referring back to FIG. 8, flowchart 800 begins with step 802. In step 802, the selected operation is indicated in a metadata map. For example, referring to FIG. 9, LOB system 108 includes an operation 930, which is the operation selected in step 702 of flowchart 700. An indication of operation 930 is included in metadata map 204.

Furthermore, operation metadata 902, which is associated with operation 930 (and received from LOB system 108 in step 708 of flowchart 700) is included in metadata map 204. Note that in FIG. 9, operation metadata 902 includes a base operation metadata 910 and an adaptor operation metadata 918. Base operation metadata 910 is operation metadata that is standard operation metadata known to metadata service 602 (is LOB independent), and thus is not retrieved from LOB system 108 in step 708. Adaptor operation metadata 918 is operation metadata that is non-standard operation metadata (is LOB specific), and thus is retrieved from LOB system 108 in step 708.

In step 804, a plurality of LOB-side parameters associated with the selected operation is determined. As described above, operation 930 includes a plurality of parameters. Metadata associated with the parameters of operation 930 is provided by LOB system 108 (e.g., in step 708 of flowchart 700), as indicated in FIG. 9 as operation parameters 904. Note that in FIG. 9, operation parameters 904 includes a base operation parameters 912 and an adaptor operation parameters 920. Base operation parameters 912 is operation parameter metadata that is standard and known to metadata service 602, and thus is not retrieved from LOB system 108 in step 708. Adaptor operation parameters 920 is operation parameter metadata that is non-standard operation parameter metadata, and thus is retrieved from LOB system 108 in step 708.

In step 806, a mapping of the plurality of LOB-side parameters to a plurality of service-side parameters is included in the metadata map. For example, LOB adaptor metadata analyzer 606 may be configured to map LOB-side parameters (indicated in operation parameters 904) to service-side parameters. As shown in FIG. 9, metadata map 204 includes a parameter mapping 932 that includes mapping information with regard to the mapped parameters.

In step 808, a plurality of LOB-side types associated with the plurality of LOB-side parameters is determined. As described above, parameters of operation 930 may have associated types. Metadata associated with the types may be provided by LOB system 108 (e.g., in step 714 of flowchart 700), as indicated in FIG. 9 as type metadata 906. Note that in FIG. 9, type metadata 906 includes a base type metadata 914 and an adaptor type metadata 922. Base type metadata 914 is type metadata that is standard type metadata known to metadata service 602, and thus is not retrieved from LOB system 108 in step 714. Adaptor type metadata 922 is type metadata that is non-standard type metadata, and thus is retrieved from LOB system 108 in step 714.

In step 810, a mapping of the plurality of LOB-side types to a plurality of service-side types is included in the metadata map. For example, LOB adaptor metadata analyzer 606 may be configured to map LOB-side types (indicated in type metadata 906) to service-side types. As shown in FIG. 9, metadata map 204 includes a type mapping 934 that includes mapping information with regard to the mapped types.

In step 812, a plurality of LOB-side type members associated with the plurality of LOB-side types is determined. As described above, types associated with parameters of operation 930 may include members. Metadata associated with the members may be provided by LOB system 108 (e.g., in step 714 of flowchart 700), as indicated in FIG. 9 as type members 908. Note that in FIG. 9, type member 906 includes a base type members 916 and an adaptor type members 924. Base type members 916 is type member metadata that is standard type member metadata known to metadata service 602, and thus is not retrieved from LOB system 108 in step 714. Adaptor type members 924 is type member metadata that is non-standard type member metadata, and thus is retrieved from LOB system 108 in step 714.

In step 814, a mapping of the plurality of LOB-side type members to a plurality of service-side type members is included in the metadata map. For example, LOB adaptor metadata analyzer 606 may be configured to map LOB-side type members (indicated in type members 908) to service-side type members. As shown in FIG. 9, metadata map 204 includes a type member mapping 936 that includes mapping information with regard to the mapped types.

As described above, in step 718 (FIG. 7), various features of metadata map 204 may be modified/configured using GUI 404 or other technique. For example, as described above, objects included in metadata map 204 may be renamed, such that the name of the object on the service-side (metadata web service 302) is different from the name of the object on the LOB-side (LOB system 108). In this manner, the object may be exposed by metadata web service 302 according to the service-side name, which may be more convenient for users/clients (e.g., a shorter name, more understandable name, etc.). Furthermore, objects included in metadata map 302 may be removed, such that even though the objects are present in LOB system 108, the removed objects are not exposed by web service 302 to users. Objects may be removed from metadata map 302 that they system integrator does not believe that clients need or will use.

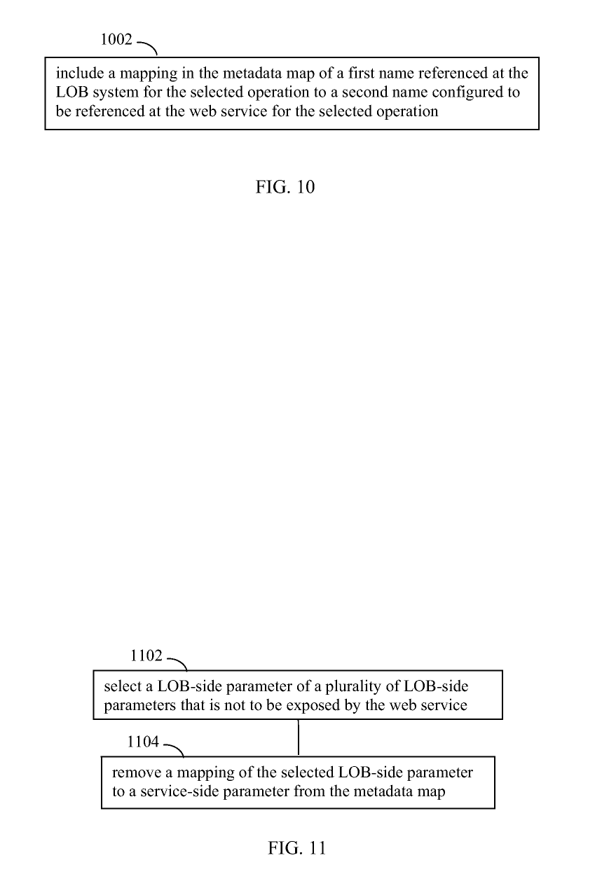

For example, FIG. 10 shows a step 1002 for renaming an operation in a metadata map 204, according to an embodiment. Further structural and operational embodiments will be apparent to persons skilled in the relevant art(s) based on the discussion regarding step 1002. In step 1002, a mapping is included in the metadata map of a first name referenced at the LOB system for the selected operation to a second name configured to be referenced at the web service for the selected operation. For example, in an embodiment, metadata map generator tool 600 may enable a name of an operation of metadata map 204 to be mapped. For example, a mapping may be included in metadata map 204 of a first name referenced at LOB system 108 for a selected operation to a second name configured to be referenced at metadata web service 302 for the selected operation. An interface for tool 600, such as GUI 404 (FIG. 4) or command line interface 504 (FIG. 5), may enable the renaming of the selected operation. The mapping may be included in operation metadata 902, for example.

In a similar manner as shown in FIG. 10 and described above for renaming an operation, a parameter, a type, and/or a type member may be renamed from a name referenced at LOB system 108 to a name referenced at metadata web service 302, by including a corresponding mapping in metadata map 204. The mapping may be included in operation parameters 904, type metadata 906, or type members 908, for the renaming of a parameter, a type, or a type member, respectively.

FIG. 11 shows a flowchart 1100 for removing a parameter of an operation in a metadata map 204, according to an embodiment. Further structural and operational embodiments will be apparent to persons skilled in the relevant art(s) based on the discussion regarding flowchart 1100.

In step 1102 of flowchart 1100, a LOB-side parameter of a plurality of LOB-side parameters is selected that is not to be exposed by the web service. For example, in an embodiment, metadata map generator tool 600 may enable one or more LOB-side parameters of a plurality of LOB-side parameters of an operation to be selected. The selected one or more LOB-side parameters are not expected to be used or needed by clients/users, and thus need not be exposed by metadata web service 302. An interface for tool 600, such as GUI 404 (FIG. 4) or command line interface 504 (FIG. 5), may enable the one or more parameters to be selected.

In step 1104, a mapping of the selected LOB-side parameter to a service-side parameter is removed from the metadata map. For example, in an embodiment, metadata map generator tool 600 may enable the mapping of the one or more LOB-side parameters to service-side parameters, which was included in metadata map 204, to be removed. For example, an interface for tool 600, such as GUI 404 (FIG. 4) or command line interface 504 (FIG. 5), may enable the selected LOB-side parameter(s) to be removed from metadata map 204 (e.g., from operation parameters 904).

In a similar manner as shown in FIG. 11 and described above for removing a parameter from metadata map 204, a type and/or a type member may be removed from metadata map 204.

As described above, in step 720 (FIG. 7), metadata map 204 is serialized into a service contract. For example, referring to FIG. 9, adaptor metadata analyzer 630 may serialize operation metadata 902, operation parameters 904, type metadata 906, and type members 908 into metadata map 204 in service description 630.

### B. Example Embodiments for Deserialization of the Metadata Map from a Service Definition for Runtime

Example embodiments are described in this subsection for runtime deserialization of the metadata map from a service definition to a format which is easy and efficient to access by an LOB adapter of the web service is described. The example embodiments described herein are provided for illustrative purposes, and are not limiting. Furthermore, additional structural and operational embodiments, including modifications/alterations, will become apparent to persons skilled in the relevant art(s) from the teachings herein.

At runtime initialization, the metadata serialized as described in the preceding subsection may be deserialized into an intermediate data structure (e.g., to a binary or in-memory representation of operation/type metadata) and made accessible to adapter runtime interfaces through a metadata map structure globally shared (read-only) by all service instances.

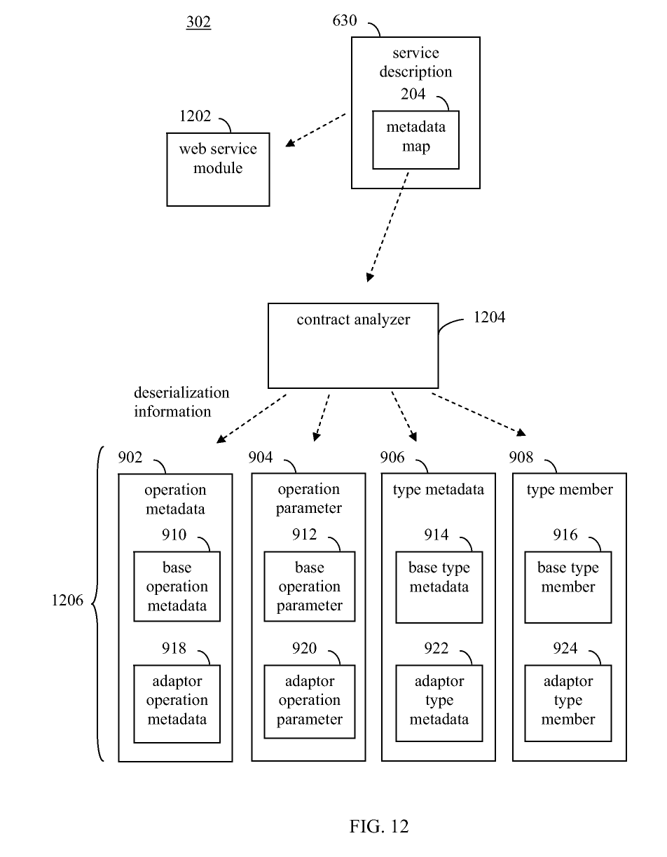

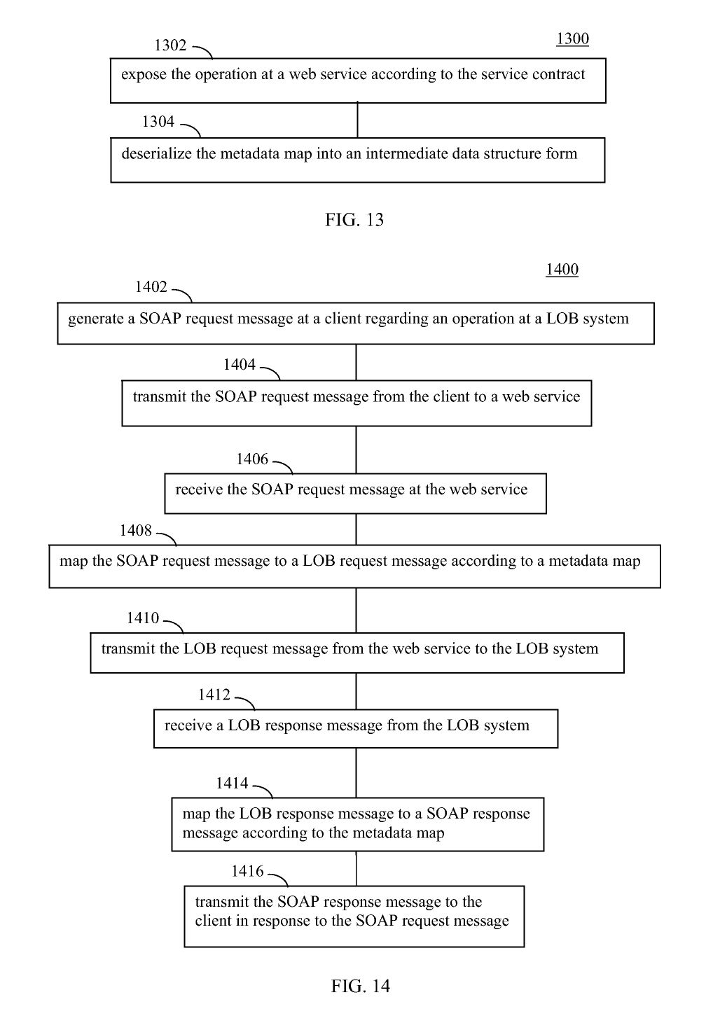

FIG. 12 shows an example of metadata web service 302 configured to perform the deserialization of metadata map 204, which was serialized as described above, into an intermediate structure form, according to an embodiment. As shown in FIG. 12, metadata web service 302 includes a web service module 1202 and a contract analyzer 1204. Metadata web service 302 is described as follows with respect to FIG. 13. FIG. 13 shows a flowchart 1300 for initializing metadata web service 302, according to an example embodiment.

Web service module 1202 may be configured to process web service contracts in a standard manner. For example, web service module 1202 may be configured to perform step 1302 of flowchart 1300. In step 1302, the operation is exposed at a web service according to the service contract. As shown in FIG. 12, web service module 1202 receives service description 630. Web service module 1302 may process service description 630 in a standard manner, including exposing metadata of metadata map 204 to users of metadata web service 302 in a standard manner, so that the corresponding operation of LOB system 108 may be accessed. For instance, in an embodiment, web service module 1202 may be configured according to the Windows Communication Foundation (WCF) programming framework distributed by Microsoft Corporation of Redmond, Wash., as a WCF service layer, or may be configured in other web service manner, as would be known to persons skilled in the relevant art(s).

Contract analyzer 1204 receives metadata map 204 from service description 630. Contract analyzer 1204 is configured to perform a deserialization process on metadata map 204. For example, contract analyzer 1204 may perform step 1304 of flowchart 1300. In step 1304, the metadata map is deserialized into an intermediate data structure form. In FIG. 12, the deserialized form of metadata map 204 is shown as deserialized metadata map 1206. Metadata map 204 is used to re-create operation metadata 902, operation parameters 904, type metadata 906, and type members 908 in a deserialized form. This process of re-creation is called a “deserialization” process. During the deserialization process, metadata map 204 is received as input (which is in a serialized form of operation metadata 902, operation parameters 904, type metadata 906, and type members 908) and metadata map 204 is de-serialized into an in-memory representation. Deserialized metadata map 1206 is an in-memory representation of operation metadata 902, operation parameter 904, type metadata 906, and type members 908.

### C. Example Embodiments for Mapping Messages Between a Web Service and a LOB System during Runtime

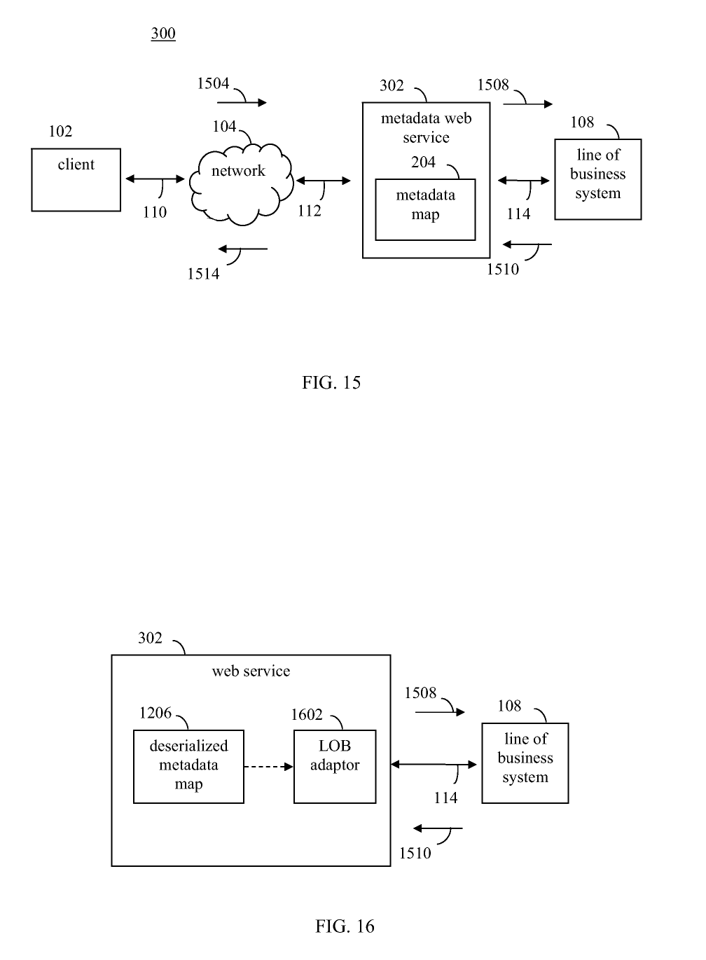

Metadata of messages that contain operations may be mapped between web services and LOB systems according to metadata maps in various ways. For example, FIG. 14 shows a flowchart 1400 describing a communication protocol for performing an operation, according to an embodiment. For instance, system 300 of FIG. 3 may perform flowchart 1400, in an embodiment. Flowchart 1400 is described with respect to FIG. 15, which shows system 300 of FIG. 3, and further illustrates communication signals, according to an example embodiment. Other structural and operational embodiments will be apparent to persons skilled in the relevant art(s) based on the discussion regarding flowchart 1400. Flowchart 1400 is described as follows.

As shown in FIG. 14, flowchart 1400 begins with step 1402. In step 1402, a SOAP request message is generated at a client regarding an operation at a LOB system.

For example, as shown in FIG. 15, client 102 may generate a request message 1504, which includes an operation to be performed by LOB system 108. Request message 1504 may be formed in SOAP format or other suitable format.

In step 1404, the SOAP request message is transmitted from the client to a web service. For instance, as shown in FIG. 15, client 102 may transmit request message 1504 that identifies the operation, and may include further information. As shown in FIG. 15, request message 1504 is transmitted through network 104.

In step 1406, the SOAP request message is received at the web service. For example, as shown in FIG. 15, metadata web service 302 may receive request message 1504, which indicates the operation.

In step 1408, the SOAP request message is mapped to a LOB request message according to a metadata map. For instance, referring to FIG. 15, metadata web service 302 is configured to map metadata received in request message 1504 from a service-side format to a LOB compatible format, according to metadata map 204. For example, FIG. 16 shows a block diagram of metadata web service 302 and LOB system 108 of FIG. 15. As shown in FIG. 16, metadata web service 302 includes a LOB adaptor 1206. LOB adaptor 1602 accessed deserialized metadata map 1206 to receive operation metadata 902, operation parameter 904, type metadata 906, and type members 908 (from deserialized metadata map 1206). LOB adaptor 1206 is configured to enable communications between metadata web service 302 and LOB system 108. Furthermore, LOB adaptor 1206 is configured to map metadata from the service-side format (e.g., in which the metadata is received by metadata service 302) to a LOB compatible format (e.g., which is recognizable by LOB system 108) according to operation metadata 902, operation parameter 904, type metadata 906, and type members 908.

In step 1410, the LOB request message is transmitted from the web service to the LOB system. For example, as shown in FIG. 15, metadata web service 302 transmits a LOB request message 1508 to LOB system 108. LOB request message 1508 indicates the operation and associated metadata mapped to the LOB compatible format. LOB system 108 is configured to perform the operation provided in LOB request message 1508.

In step 1412, a LOB response message is received from the LOB system. For example, as shown in FIG. 15, LOB system 108 generates an LOB response message 1510, which is received by metadata web service 302.

In step 1414, the LOB response message is mapped to a SOAP response message according to the metadata map. For example, as shown in FIG. 15, metadata web service 302 is configured to map metadata received in LOB response message 1510 from the LOB compatible format to a service-side format, according to metadata map 204. For instance, referring to FIG. 16, LOB adaptor 1206 is configured to map metadata from the LOB compatible format received from LOB system 108 to the service-side format according to deserialized metadata map 1206.

In step 1416, the SOAP response message is transmitted to the client in response to the SOAP request message. For example, as shown in FIG. 15, metadata web service 302 generates a SOAP response message 1514 that includes information included in LOB response message 1510, mapped into service-side format. As shown in FIG. 15, SOAP response message 1514 is transmitted through network 104, and is received by client 102.

### III. Further Example Embodiments

Metadata map generator 202, metadata web service 302, GUI generator 402, command line entry interface module 502, metadata service 602, LOB adaptor metadata handler 604, LOB adaptor metadata analyzer 606, web service module 1202, contract analyzer 1204, and LOB adaptor 1602 may be implemented in hardware, software, firmware, or any combination thereof For example, metadata map generator 202, metadata web service 302, GUI generator 402, command line entry interface module 502, metadata service 602, LOB adaptor metadata handler 604, LOB adaptor metadata analyzer 606, web service module 1202, contract analyzer 1204, and/or LOB adaptor 1602 may be implemented as computer program code configured to be executed in one or more processors. Alternatively, metadata map generator 202, metadata web service 302, GUI generator 402, command line entry interface module 502, metadata service 602, LOB adaptor metadata handler 604, LOB adaptor metadata analyzer 606, web service module 1202, contract analyzer 1204, and/or LOB adaptor 1602 may be implemented as hardware logic/electrical circuitry.

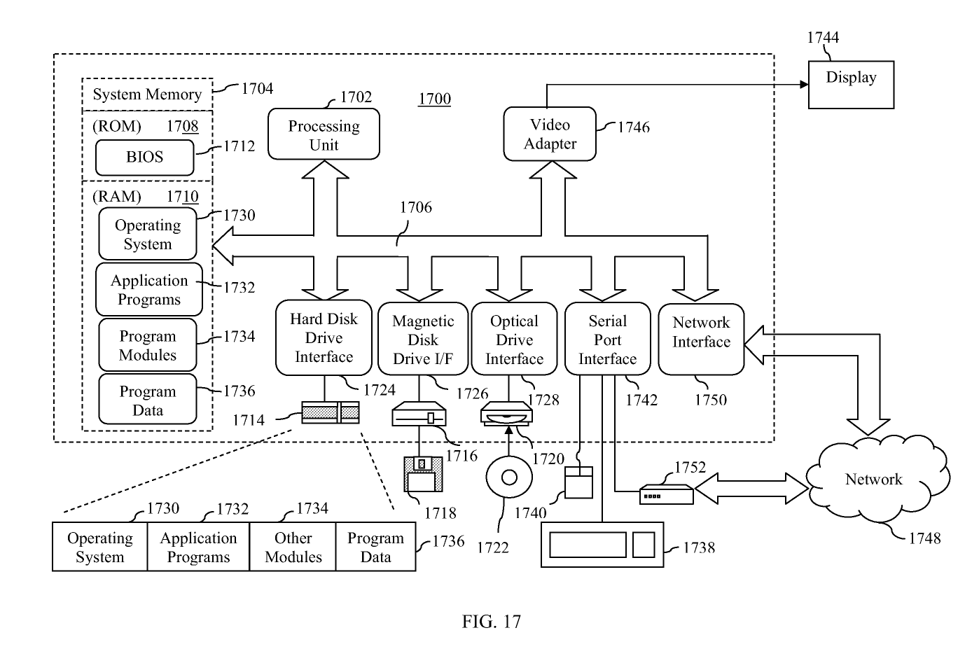

FIG. 17 depicts an exemplary implementation of a computer 1700 in which embodiments of the present invention may be implemented. For instance, client 102, web service 302, metadata map generator tool 600, and/or LOB system 108 may be implemented in computers similar to computer 1700. Computer 1700 may be a general-purpose computing device in the form of a conventional personal computer, a mobile computer, or a workstation, for example, or computer 1700 may be a special purpose computing device. The description of computer 1700 provided herein is provided for purposes of illustration, and is not intended to be limiting. Embodiments of the present invention may be implemented in further types of computer systems, as would be known to persons skilled in the relevant art(s).

As shown in FIG. 17, computer 1700 includes a processing unit 1702, a system memory 1704, and a bus 1706 that couples various system components including system memory 1704 to processing unit 1702. Bus 1706 represents one or more of any of several types of bus structures, including a memory bus or memory controller, a peripheral bus, an accelerated graphics port, and a processor or local bus using any of a variety of bus architectures. System memory 1704 includes read only memory (ROM) 1708 and random access memory (RAM) 1710. A basic input/output system 1712 (BIOS) is stored in ROM 1708.

Computer 1700 also has one or more of the following drives: a hard disk drive 1714 for reading from and writing to a hard disk, a magnetic disk drive 1716 for reading from or writing to a removable magnetic disk 1718, and an optical disk drive 1720 for reading from or writing to a removable optical disk 1722 such as a CD ROM, DVD ROM, or other optical media. Hard disk drive 1714, magnetic disk drive 1716, and optical disk drive 1720 are connected to bus 1706 by a hard disk drive interface 1724, a magnetic disk drive interface 1726, and an optical drive interface 1728, respectively. The drives and their associated computer-readable media provide nonvolatile storage of computer-readable instructions, data structures, program modules and other data for the computer. Although a hard disk, a removable magnetic disk and a removable optical disk are described, other types of computer-readable media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1730, one or more application programs 1732, other program modules 1734, and program data 1736.

Application programs 1732 or program modules 1734 may include, for example, computer program logic for implementing metadata map generator 202, metadata web service 302, GUI generator 402, command line entry interface module 502, metadata service 602, LOB adaptor metadata handler 604, LOB adaptor metadata analyzer 606, web service module 1202, contract analyzer 1204, LOB adaptor 1602, flowchart 700, flowchart 800, step 1002, flowchart 1100, flowchart 1300, and/or flowchart 1400 (including any step of flowcharts 700, 800, 1100, 1300, and/or 1400), and/or any further embodiments as described above.

A user may enter commands and information into the computer 1700 through input devices such as keyboard 1738 and pointing device 1740. Other input devices (not shown) may include a microphone, joystick, game pad, satellite dish, scanner, or the like. These and other input devices are often connected to the processing unit 1702 through a serial port interface 1742 that is coupled to bus 1706, but may be connected by other interfaces, such as a parallel port, game port, or a universal serial bus (USB).

A monitor 1744 or other type of display device is also connected to bus 1706 via an interface, such as a video adapter 1746. In addition to the monitor, computer 1700 may include other peripheral output devices (not shown) such as speakers and printers.

Computer 1700 is connected to a network 1748 (e.g., the Internet) through a network adaptor or interface 1750, a modem 1752, or other means for establishing communications over the network. Modem 1752, which may be internal or external, is connected to bus 1706 via serial port interface 1742.

As used herein, the terms “computer program medium” and “computer-readable medium” are used to generally refer to media such as the hard disk associated with hard disk drive 1714, removable magnetic disk 1718, removable optical disk 1722, as well as other media such as flash memory cards, digital video disks, random access memories (RAMs), read only memories (ROM), and the like.

As noted above, computer programs and modules (including application programs 1732 and other program modules 1734) may be stored on the hard disk, magnetic disk, optical disk, ROM, or RAM. Such computer programs may also be received via network interface 1750 or serial port interface 1742. Such computer programs, when executed or loaded by an application, enable computer 1700 to implement features of embodiments of the present invention discussed herein. Accordingly, such computer programs represent controllers of the computer 1700.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### IV. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for interfacing a web service with a line of business (LOB) system, comprising:
selecting an operation of the LOB system that the LOB system is configured to perform;
indicating the selected operation in a metadata map;
determining a plurality of LOB-side parameters associated with the selected operation;
including a first mapping of the plurality of LOB-side parameters to a plurality of service-side parameters in the metadata map;
determining a plurality of LOB-side types associated with the plurality of LOB-side parameters;
including a second mapping of the plurality of LOB-side types to a plurality of service-side types in the metadata map; and
serializing the metadata map.

2. The method of claim 1, wherein said indicating the selected operation in a metadata map comprises:
including a mapping in the metadata map of a first name referenced at the LOB system for the selected operation to a second name configured to be referenced at the web service for the selected operation.

3. The method of claim 1, wherein said including a first mapping of the plurality of LOB-side parameters to a plurality of service-side parameters in the metadata map comprises:
selecting a LOB-side parameter of the plurality of LOB-side parameters that is not to be exposed by the web service; and
removing a mapping of the selected LOB-side parameter to a service-side parameter from the first mapping.

4. The method of claim 1, wherein said including a first mapping of the plurality of LOB-side parameters to a plurality of service-side parameters in the metadata map comprises:
including in the first mapping a mapping of a first name referenced at the LOB system for a LOB-side parameter to a second name configured to be referenced at the web service for a service-side parameter that corresponds to the LOB-side parameter.

5. The method of claim 1, wherein said including a second mapping of the plurality of LOB-side types to a plurality of service-side types in the metadata map comprises:
including in the second mapping a mapping of a first name referenced at the LOB system for a LOB-side type to a second name configured to be referenced at the web service for a service-side type that corresponds to the LOB-side type.

6. The method of claim 1, wherein said including a second mapping of the plurality of LOB-side types to a plurality of service-side types in the metadata map comprises:
including in the second mapping a mapping of a first name referenced at the LOB system for a LOB-side type member to a second name configured to be referenced at the web service for a service-side type member that corresponds to the LOB-side type member.

7. The method of claim 1, wherein said serializing comprises:
serializing the metadata map into a service contract.

8. The method of claim 7, wherein said serializing comprises:
serializing an operation metadata, an operation parameter, a type metadata, and a type member into the service contract.

9. The method of claim 1, further comprising:
initializing the web service by at least deserializing the metadata map from a service contract.

10. The method of claim 9, wherein said initializing comprises:
deserializing an operation metadata, an operation parameter, a type metadata, and a type member from the service contract.

11. The method of claim 1, further comprising:
receiving a SOAP request message from a client regarding the operation;
mapping the SOAP request message to a LOB request message according to the generated metadata map;
transmitting the LOB request message to the LOB system;
receiving a LOB response message from the LOB system;
mapping the LOB response message to a SOAP response message according to the generated metadata map;
transmitting the SOAP response message to the client in response to the SOAP request message.

12. The method of claim 11, wherein said mapping the SOAP request message to a LOB request message according to the generated metadata map comprises:
mapping the SOAP request message to a LOB request message according to a deserialized version of the generated metadata map; and
wherein said mapping the LOB response message to a SOAP response message according to the generated metadata map comprises:
mapping the LOB response message to a SOAP response message according to the deserialized version of the generated metadata map.

13. A metadata map generator tool, comprising:
a metadata service configured to receive a request from a user to retrieve metadata for an operation from a line of business (LOB) system;
a metadata handler configured to provide an operation metadata request to the LOB system based on the request received from the user, and to receive operation metadata associated with the operation from the LOB system; and
a metadata analyzer configured to generate a metadata map based at least on the operation metadata, and to serialize the metadata map into a service contract.

14. The metadata map generator tool of claim 13, wherein the metadata service is configured to determine whether the operation metadata includes one or more parameters that reference a complex type;
the metadata handler being configured to provide a type metadata request associated with the complex type to the LOB system, and to receive type metadata associated with the complex type from the LOB system, if the complex type is determined to referenced; and
the metadata analyzer being configured to generate the metadata map based at least on the operation metadata and the type metadata.

15. The metadata map generator tool of claim 13, further comprising:
an interface module configured to generate an interface to enable the user to select the operation of the LOB system to generate a metadata map for the selected operation.

16. The metadata map generator tool of claim 13, further comprising:
an interface module configured to generate an interface to enable the user to modify the generated metadata map.

17. The metadata map generator tool of claim 16, wherein the interface is configured to enable the user to perform at least one of changing a service-side name of the operation, a service-side name of a parameter of the operation, a service-side name of a type associated with the parameter, or a service-side name of a type member associated with the type.

18. The metadata map generator tool of claim 16, wherein the interface is configured to enable the user to configure at least one of a parameter of the operation or a type member of a type associated with the parameter to not be exposed on the service-side.

20. A web service, comprising:
a web service module configured to expose an operation of a line of business (LOB) system at the web service according to a service contract, the service contract including a serialized metadata map that maps metadata associated with the operation between the web service and the LOB system;
a contract analyzer configured to deserialize the metadata map into an intermediate data structure form; and
an LOB adaptor configured to map metadata messages between the web service and the LOB system according to the deserialized metadata map.
